(19) United States
(12) Patent Application Publication
(10) Pub. No.: US 2026/0009922 A1
(43) Pub. Date: Jan. 8, 2026

(54) SYSTEMS AND METHODS FOR IMPROVING SEISMIC DATA ANALYSIS USING DITHERING TECHNIQUES

(71) Applicant: Schlumberger Technology Corporation, Sugar Land, TX (US)

(72) Inventors: Alexander ZARKHIDZE, Crawley (GB); Rajiv KUMAR, Crawley (GB); Massimiliano VASSALLO, Crawley (GB); Franck LE DIAGON, Crawley (GB); Gary POOLE, Crawley (GB); Robert BLOOR, Houston, TX (US)

(21) Appl. No.: 19/130,578

(22) PCT Filed: Mar. 28, 2024
(86) PCT No.: PCT/US2024/021926

§ 371 Date: May 16, 2025

Related U.S. Application Data
(60) Provisional application No. 63/456,130, filed on Mar. 31, 2023.

(51) Int. Cl. G01V 1/38

(52) U.S. Cl. CPC G01V 1/3808; G01V 1/3817; G01V 2210/127

(57) ABSTRACT

System and method for designing dithers having a pre-determined distribution within a dithers range, wherein the dithers range is chosen for the seismic survey, wherein a lower boundary of the dithers range is 4 seconds or +2 seconds dithers distribution relative to nominal shotting times of sources of seismic waves in the seismic survey, and wherein an upper boundary of the dithers range is a largest value compatible with constraints of the seismic survey.

### CROSS-REFERENCE TO RELATED APPLICATIONS

This application claims priority to U.S. Provisional Patent Application No. 63/456,130 filed on Mar. 31, 2023, which is incorporated by reference herein.

### BACKGROUND

The present disclosure relates generally to performing multiple types of seismic surveys in water. More specifically, the present disclosure relates to exploring geologic areas using improved seismic acquisition techniques.

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

Seismic exploration in certain water areas having complex geological structures may be challenging. Various water properties (e.g., shallow) and geological complexities may create difficulties in seismic data acquisitions (e.g., surveys) and post-acquisition data processing (e.g., noise attenuation, subsurface imaging, velocity model building). Dithering while performing seismic acquisitions may improve the noise attenuation processing involved for seismic data analysis. However, some dithering techniques may reduce the efficiencies in which noise attenuation may be performed.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for localizing a coherent seismic signal from data collected during a seismic survey. The method also includes designing dithers having a pre-determined distribution within a dithers range, where the dithers range is chosen for the seismic survey, where a lower boundary of the dithers range is relative to the fraction of the nominal shooting times of sources of seismic waves in the seismic survey, and where an upper boundary of the dithers range is a largest value compatible with constraints of the seismic survey, where the seismic survey includes nominal positions of the sources. The method also includes designing survey positions of each of the sources by adding the designed dithers to the nominal positions relative to an underlying grid of the seismic survey. The method also includes activating each of the sources at the designed survey positions. The method also includes receiving a plurality of seismic waves generated as a result of the source activations, where the sources are activated to generate the seismic waves, and where the sources include an adjacent pair of sources. The method also includes localizing a coherent signal from the received seismic waves that is distinct in a randomly distributed interference noise during source separation processing in a sparsity promoting domain. Other embodiments of this aspect include corresponding computer systems, apparatus, and computer programs recorded on one or more computer storage devices, each configured to perform the actions of the methods.

Another general aspect includes a computing system for localizing a coherent seismic signal from data collected during a seismic survey. The computing system also includes one or more processors; and a memory system may include one or more non-transitory computer-readable media storing instructions that, when executed by at least one of the one or more processors, cause the computing system to perform operations. The operations include designing dithers having a pre-determined distribution within a dithers range, where the dithers range is chosen for the seismic survey, where a lower boundary of the dithers range is relative to fraction of the nominal shotting times of sources of seismic waves in the seismic survey, and where an upper boundary of the dithers range is a largest value compatible with constraints of the seismic survey, where the seismic survey includes nominal positions of the sources. The operations also include designing survey positions of each of the sources by adding the designed dithers to the nominal positions relative to an underlying grid of the seismic survey. The operations also include activating each of the sources at the designed survey positions. The operations also include receiving a plurality of seismic waves generated as a result of the source activations, where the sources are activated to generate the seismic waves, and where the sources may include an adjacent pair of sources. The operations also include localizing a coherent signal from the received seismic waves that is distinct in a randomly distributed interference noise during source separation processing in a sparsity promoting domain. Other embodiments of this aspect include corresponding computer systems, apparatus, and computer programs recorded on one or more computer storage devices, each configured to perform the actions of the methods.

Yet another general aspect includes a non-transitory computer-readable medium for localizing a coherent seismic signal from data collected during a seismic survey. The medium stores instructions that, when executed by one or more processors of a computing system, cause the computing system to perform operations. The operations include designing dithers having a pre-determined distribution within a dithers range, where the dithers range is chosen for the seismic survey, where a lower boundary of the dithers range is 4 seconds (for a total dithers distribution of ±2 seconds relative to nominal shotting times of sources of seismic waves in the seismic survey). The upper boundary of the dithers range is a largest value compatible with constraints of the seismic survey. The seismic survey includes nominal positions of the sources, and the upper boundary of the dither range is based on a maximum separation time between when the sources are activated. The dither range is based on, for example, but not limited to, a spacing of the sources, a speed of a vessel towing the sources, and cycle times of the sources.

In some configurations, the seismic waves propagate downward into subterranean geologic structures, and the sources include, for example, but not limited to, one or more source arrays, and/or a plurality of air guns. In some configurations, the seismic survey includes ocean bottom node sensors, and the ocean bottom node sensors include one or more geophones. The one or more geophones are, for example, but not limited to, single-component, two-component, or three-component. In some configurations, the ocean bottom node sensors include hydrophones, and the seismic survey includes one or more streamers traversing water. In some configurations, the vessel tows the one or more streamers along a sail line, each of the one or more streamers includes one or more streamer sensors, and the one or more streamer sensors may include one or more hydrophones. The one or more hydrophones create electrical signals in response to water pressure changes caused by reflected seismic waves arriving at the hydrophones. In some configurations, the seismic survey includes one or more near field hydrophones in proximity to the sources, and the seismic survey includes one or more seismic sensors in one or more wells drilled into a subterranean geological structure. In some configurations, the one or more seismic sensors includes fiber-optic sensors, geophones, and/or hybrid sensors including both fiber-optic sensors and geophones. In some configurations, source light signals are provided to the fiber-optic sensors, and the source light signals may include laser impulses, wavelength tunable lasers, vertical cavity surface-emitting lasers, external cavity lasers, and/or distributed feedback lasers. In some configurations, the hybrid sensors are disposed along a cable deployed in a borehole of the one or more wells, and the one or more sensors measure strains caused by the seismic waves traveling along a sensor array. The one or more sensors are measuring ground motions caused by the seismic waves traveling along the sensor array. The one or more seismic sensors convert received light data to digital signals. The sources are activated to generate the seismic waves. In some configurations, the sources are activated randomly. The one or more seismic sensors receive reflected seismic waves and measure the reflected seismic waves.

The operations also include receiving the constraints including environmental constraints and instrumental constraints, where the environmental constraints include an energy threshold above which more energy cannot be injected over a time period, and the amount of energy that can be injected is based on a minimum separation between two sources and the energy threshold. The operations also include designing survey positions of each of the sources by adding the designed dithers to the nominal positions relative to an underlying grid of the seismic survey. The operations also include maintaining a cycle time between the sources based on a design of the seismic survey. The operations also include activating each of the sources at the designed survey positions. The operations also include receiving a plurality of seismic waves generated as a result of the source activation, where the sources are activated to generate the seismic waves, and where the sources include an adjacent pair of the sources. The operations also include localizing a coherent signal from the received seismic waves that is distinct in a randomly distributed interference noise during source separation processing in a sparsity promoting domain. The operations also include displaying the coherent signal. The operations also include performing a wellsite action in response to the coherent signal. Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a schematic diagram of a water seismic survey using multiple seismic measurements, in accordance with embodiments described herein;

FIG. 2 illustrates an example dither design optimizing separation between consecutive sources, in accordance with embodiments described herein;

FIGS. 3A-3C illustrate exemplary multi-source multi-vessel design, in accordance with embodiments described herein;

FIG. 4 is a pictorial example of the large dither range and dither distributions in accordance with embodiments of the present disclosure; and

FIGS. 5A and 5B are flowcharts of a method in accordance with embodiments of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. It should be noted that the term “multimedia” and “media” may be used interchangeably herein.

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

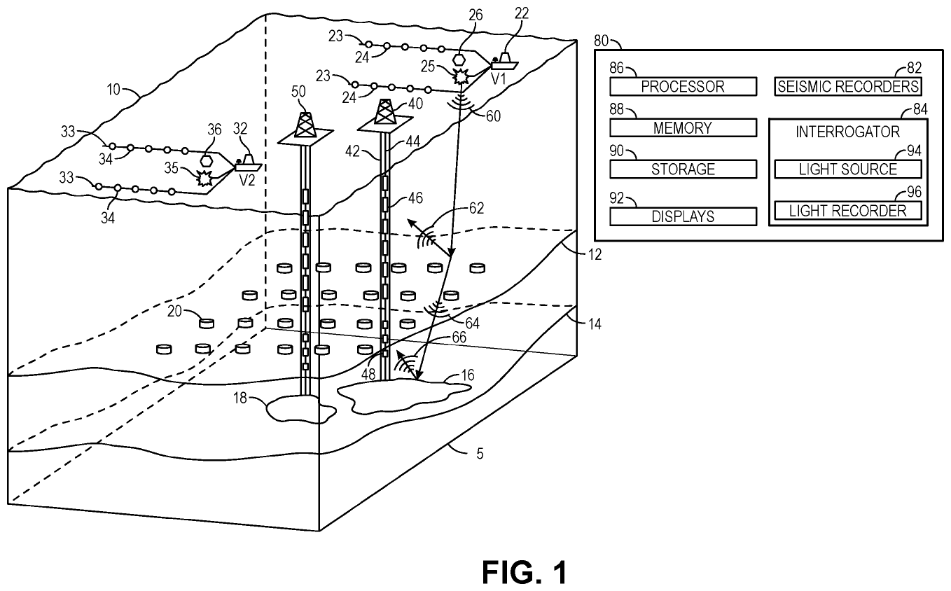

FIG. 1 illustrates a schematic diagram of a water seismic survey using multiple seismic measurements. A water area may include a surface 10 and a water bottom 12. Water depth in the water area may vary from a few meters to any suitable number of meters. Multiple subsurface layers (e.g., subsurface layers 14 and 15) may locate beneath the water bottom 12. Geological formations, such as subsurface formations 16 and 18 embedded in the subsurface layers, may contain hydrocarbon deposits. Seismic data acquired in the water seismic survey may be used to image the water bottom 12, the subsurface layers 14 and 15, and the subsurface formations 16 and 18. Images of subterranean geologic structures may provide indications of the hydrocarbon deposits.

The water seismic survey may include ocean bottom node (OBN) measurement by employing multiple OBNs 20 on the water bottom 12. The OBNs may be deployed (e.g., using remotely operated vehicles (ROVs)) to selected locations and form a certain geometry (e.g., an OBN patch with 200 meters by 200 meters grid size). Each of the OBNs 20 may include one or more OBN sensors. The OBN sensors may include one or more geophones (e.g., single-component, two-component, three-component geophones). In some embodiments, the OBN sensors may also include hydrophones.

One or more seismic source vessels may be used in the water seismic survey. For example, a source vessel 22 towing a seismic source 25 and another source vessel 32 towing another seismic source 35 may be used to create seismic waves propagating downward into the subterranean geologic structures. Each of the seismic sources 25 and 35 may include one or more source arrays and each source array may include a certain number of air guns.

The water seismic survey may also include streamer measurement by employing multiple streamers traversing the water. For example, the source vessel 22 may tow multiple (e.g., two, four, six, eight, or ten) streamers 23 along one sail line, and the source vessel 32 may tow multiple streamers 33 along another sail line. The streamer measurement may be acquired using shots fired by the seismic sources 25 and 35. Each streamer may include multiple streamer sensors. For example, each of the streamers 23 may include streamer sensors 24 and each of the streamers 33 may include streamer sensors 34. The streamer sensors 24 and 34 may include hydrophones that create electrical signals in response to water pressure changes caused by reflected seismic waves that arrive at the hydrophones.

The water seismic survey may also include near field hydrophone (NFH) measurement by employing multiple NFHs close to the seismic sources. For example, an NFH 26 may be deployed in close proximity to the seismic source 25 and another NFH 36 may be deployed in close proximity to the seismic source 35.

The water seismic survey may further include vertical seismic profile (VSP) measurement by employing seismic sensors (e.g., fiber-optic sensors, geophones, or hybrid sensors) in one or more wells. For example, a hybrid sensor array including fiber-optic sensors 46 and geophones 48 may be disposed along a wireline cable 44 deployed in a borehole 42 of a well 40, which may be drilled into the subsurface formation 16. Similar seismic sensors may be deployed in another well 50, which may be drilled into the formation 18. The fiber-optic sensors 46 may measure strains caused by reflected or refracted seismic waves traveling along the hybrid sensor array. The geophone 48 may measure ground motions (e.g., particle movements such as velocity and acceleration) caused by seismic waves traveling along the hybrid sensor array.

During the water seismic survey, the seismic source 25 may be activated to generate seismic waves 60 traveling downward into the subterranean geologic structures. When the seismic waves 60 arrive at the water bottom 12, a portion of seismic energy contained in the seismic waves 60 is reflected by the water bottom 12. Reflected waves 62 travel upward and arrive at different sensors, such as the streamer sensors 24 and 34, the near field hydrophones 26 and 36, and the fiber-optic sensors 46, where they are measured by corresponding sensors. Another portion of the seismic energy contained in transmitted seismic waves 64 propagated through the water bottom 12 into the subsurface layer 14. A portion of seismic energy contained in the transmitted waves 64 is reflected by the subsurface formation 16. Reflected waves 66 travel upward and arrive at the different sensors, where they are measured by the corresponding sensors.

It should be noted that the elements described above with regard to the water seismic survey are exemplary elements. For instance, some embodiments of the water seismic survey may include additional or fewer elements than those shown. In some embodiments, the water seismic survey may include different number of source vessels. In some embodiments, separated receiver vessels may be used to tow the streamers. In some embodiments, the streamer measurement may be acquired independently from the OBN measurement for operational or logistical reasons.

Seismic data simultaneously acquired from different sensors may be collected and processed by a processing system 80. The processing system 80 may include one or more seismic recorders 82, an interrogator 84, a processor 86, a memory 88, a storage 90, and one or more displays 92. The one or more seismic recorders 82 may receive ocean bottom node (OBN) data from OBNs 20, streamer data from streamer sensors 24 and 34, near field hydrophone (NFH) data from the NFHs 26 and 36, and a portion of vertical seismic profile (VSP) data from geophones 48. The interrogator 84 may receive another portion of VSP data from the fiber-optic sensors 46. Collected data may be processed by the processor 86 using processor-executable code stored in the memory 88 and the storage 90. The processed data may be stored in the storage 90 for later usage. Processing results may be displayed via the one or more displays 92.

The interrogator 84 may include a light source 94 that may provide source light signals (e.g., laser impulses) for the fiber-optic sensors 46. For example, the light source 94 may include wavelength tunable lasers (e.g., semiconductor lasers), such as distributed Bragg reflector (DBR) laser, vertical cavity surface-emitting laser (VCSEL), external cavity laser, distributed feedback (DFB) laser, or other suitable lasers. The interrogator 84 may also include a light recorder 96 that may receive light signals (e.g., back scattered light signals associated with local measurement of dynamic strains caused by incident seismic waves) from the fiber-optic sensors 46 and convert the light signals to electrical signals (e.g., using photodetectors).

The processor 86 may be any type of computer processor or microprocessor capable of executing computer-executable code. The processors 86 may include single-threaded processor(s), multi-threaded processor(s), or both. The processors 86 may also include hardware-based processor(s) each including one or more cores. The processors 86 may include general purpose processor(s), special purpose processor(s), or both. The processors 86 may be communicatively coupled to other components (such as one or more seismic recorders 82, interrogator 84, memory 88, storage 90, and one or more displays 92).

The memory 88 and the storage 90 may be any suitable articles of manufacture that can serve as media to store processor-executable code, data, or the like. These articles of manufacture may represent computer-readable media (e.g., any suitable form of memory or storage) that may store the processor-executable code used by the processor 86 to perform the presently disclosed techniques. The memory 88 and the storage 90 may also be used to store data described (e.g., fiber sensor data, geophone data), various other software applications for seismic data analysis and data processing. The memory 88 and the storage 90 may represent non-transitory computer-readable media (e.g., any suitable form of memory or storage) that may store the processor-executable code used by the processor 86 to perform various techniques described herein. It should be noted that non-transitory merely indicates that the media is tangible and not a signal.

The one or more displays 92 may operate to depict visualizations associated with software or executable code being processed by the processor 86. The display 66 may be any suitable type of display, such as a liquid crystal display (LCD), plasma display, or an organic light emitting diode (OLED) display.

It should be noted that the components described above with regard to the processing system 80 are exemplary components and the processing system 80 may include additional or fewer components as shown. For example, the processing system 80 may include one or more communication interfaces to send commands to different seismic acquisition systems and receive measurement from the different seismic acquisition systems.

Keeping the foregoing in mind, it should be noted that water seismic surveys are performed using simultaneous source acquisition to acquire longer-offsets data while keeping the acquisition cost low. In some embodiments, the seismic sources 25 and 35 and the streamer sensors 24 may be positioned according to a design source and receiver layout on a periodic grid, while a relatively small dither (e.g., 100 mms-1 s) may be applied between the shots of the seismic sources 25 and 35 to create randomization in the interference noise. The randomized interference noise may be removed to identify the source signal in the resulting seismic data acquisition.

It should be noted that seismic surveys may be constrained by environmental and instrumental restrictions, such as not being able to inject energy above some threshold or maintaining some amount of time to allow for activation time between the firing of consecutive sources. As such, adding dithers between source activations may assist in localizing a coherent signal that is distinct in the randomly distributed interference noise during source separation processing in the sparsity domain. In other words, identifying the coherent signal becomes relatively easier using the dithering techniques as compared to without using the dithering techniques.

With this in mind, the small amount of randomization provided in the interference noise due to the dithers may result in a somewhat coherent appearance of interference noise. However, it may be difficult to identify signals from this noise during source separation processing operations. As such, to mitigate the relatively small noise interference injected into the seismic data caused by the dithers, seismic data processing and analysis techniques may carefully process the simultaneous data to ensure that a coherent signal buried beneath the strong and somewhat coherent interference noise may be identified. These processing and analysis techniques may be time consuming and inaccurate depending on the similarities between the desired signals and the interference noise.

Accordingly, in some embodiments of the present disclosure, seismic survey design may include an acquisition survey with larger dithers following the theory of compressive sensing. That is, in some survey acquisition designs, minimum and maximum dithers within the dither range and a minimum activation time (e.g., cycle time) between sources as determined based strictly on instrument and environmental constraints may be specified by some user and this range may be used to determine dither values. As such, the determined dither values may be randomly selected without actually providing the resulting interference noise that may maximize the randomization in interference and randomizing the dither separation between consecutive sources.

To improve or increase the randomization in interference and randomization in dither separation between consecutive sources, in some embodiments, the seismic survey design may maintain the cycle time between sources while selecting dither values that randomly optimize the separation between consecutive sources while accounting for the cycle time. The term “dithers,” as used herein, is the time shift to introduce randomization with respect to nominal shotting times. The dithers can be positive or negative. The range of the dithers is computed as twice the maximum absolute value of dithers allowed in the calculated distribution. For a given scenario with one or more sources on one or multiple vessels, in embodiments in accordance with the present disclosure, the dither range is maximized while adhering to the constraints of the maximum nominal time interval for a single source or even surpassing the nominal time interval for a single source out of the one or more sources. In some configurations, the lower bound of the dither range can include any value starting from four seconds (+/−2 seconds relative to nominal shotting times) to the maximum nominal time interval for a single source, and is set with specific considerations tailored to the requirements of the survey and its operational parameters. In some configurations, the upper bound of the dither range is subject to further constraints imposed by hardware, software, environmental considerations, and specific survey configurations such as, but not limited to, the near-field hydrophones requirements.

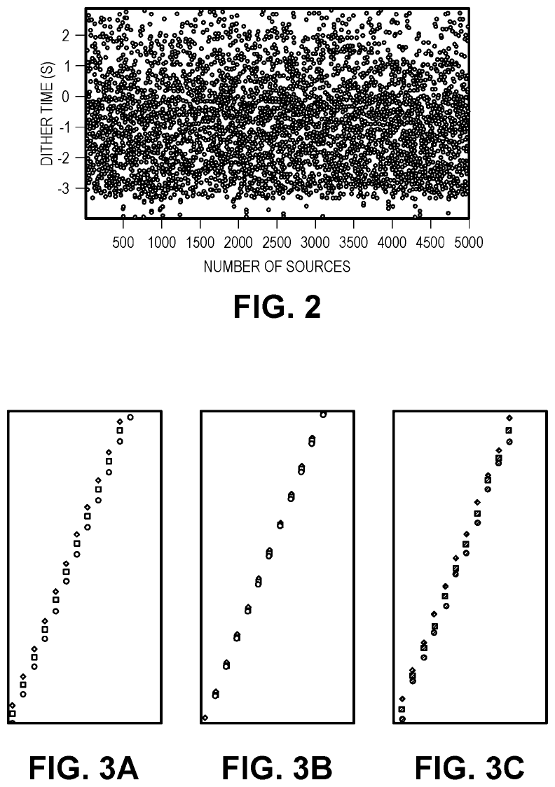

In some configurations, the range of dither values may extend up to a maximum separation time in which a subsequent source may be activated. For example, three sources may be activated sequentially one after the other within 6 seconds of separation (e.g., separation time) including a cycle time of 3 seconds. This activation design results in an overall 18 second recording time period before the same source activates again. In some embodiments, the sources may be activated randomly, such that a minimum dither time is 0 seconds and maximum dither time is nominal time difference between two consecutive sources (e.g. 0-6), while optimizing the separation between sources. Dither is the perturbation with respect to nominal. Dither range is constrained by acquisition systems or operational requirements or environmental regulations. Additionally, the randomized dither generation may be continuously repeated in pairs of 3 sources until the entire source line is covered. In this way, a number of possible randomized dither scenarios within 6 seconds along each source line may be performed. By way of example, FIG. 2 illustrates an example dither generation for three source scenarios where each source line is 60 km long. The illustrated dither design optimizes the separation between consecutive sources.

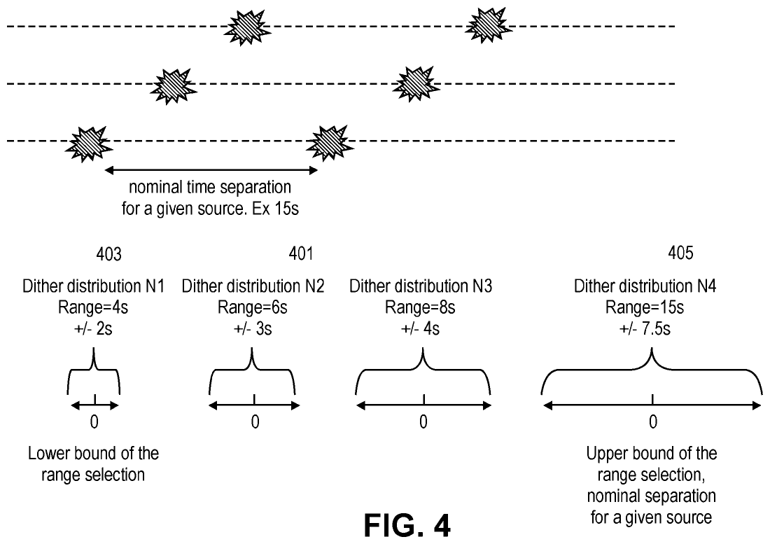

FIGS. 3A-3C illustrate optimal positions of the three sources while maximizing the dithers. Specifically, FIGS. 3A-3C illustrate a conventional multi-source, multi-vessel design for the marine environment where three sources on each vessel are activated. FIG. 3A illustrates a flip-flop-flap activation every 16.66 m, and FIG. 3B illustrates a flip-flip-flip activation with a ±1 second dither value. FIG. 3C illustrates grid locations using a maximum possible dithers selected in accordance with embodiments of the present disclosure while optimizing source separation between consecutive sources.

Continuing the three-source example mentioned above, the survey design may include dithers that are globally designed, such that the dither range of each active source is connected to the manner in which the dithers are imposed on previously activated sources. As a result, the resulting dithers provide higher randomization of interference noise along the source line as opposed to assigning minimum and maximum dithers to neighboring sources based strictly on cycle time, as performed in other survey designs. That is, in some embodiments, the dither time employed between each source activation may be randomized to be different values within the range indicated by the design. Indeed, by including dither times up to the maximum amount of separation time, the resulting interference noise may be maximized, thereby allowing signal identification during source separation processing of seismic data analysis more efficient.

By randomizing the dither times between source activation using the time range up to and including the maximum value of the source activation time interval, the interference noise from different sources may be highly randomized making source separation processes more robust and efficient compared to traditional seismic survey designs.

In another embodiment, the seismic survey designs may be prepared to ensure that each source along a respective sail line has an equal probability of having maximum dither value irrespective of a length of the respective sail line. In this way, the present embodiments described herein allow randomization to remain consistent throughout the sail line. As a result, later sources on a sail line avoid having lower dithers values as compared to earlier activated sources.

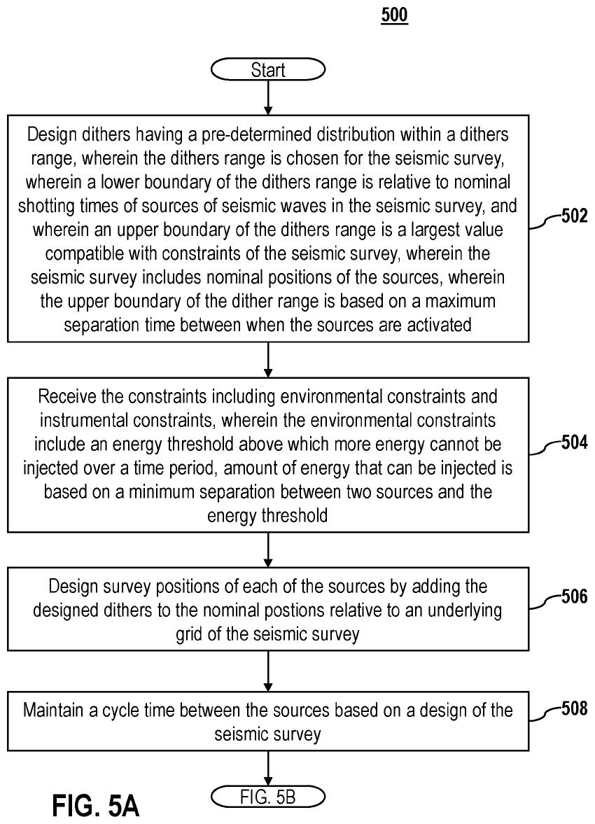

Referring now to FIG. 4, the dithers can be positive or negative, and belong to the distribution of the dithers for a given survey. In some configurations, the range of the dithers distribution for the entire survey is twice the maximum absolute value of dithers allowed in the calculated distribution. For example, as shown in dither distribution N2 401, if the range value is 6 seconds, the dithers distribution is ±3 seconds. In some configurations, one type of dither distribution with a fixed value of the range is designed for a survey, meaning that for a given survey the range value is a number, for example, 6 seconds, giving ±3 seconds distribution.

For each survey, the distribution is widened and the value of the range is maximized, providing a design of the distribution of the dithers in which the range value is as large as possible. This range value is maximized within bounds, where the lower value is 4 seconds as shown in N1 403, while the higher bound is a nominal time separation for a given source, but is set with specific considerations tailored to the requirements of the survey and its operational parameters. For example, if a dither distribution N4 405, with range of 15 seconds (±7.5 seconds dithers distribution for the survey), is selected, but due to, for example, but not limited to, environmental constraints, hardware constraints, and near field hydrophone requirements, dither distribution N2 401 with the range value of 6 seconds (+/−3 seconds) is the resulting distribution.

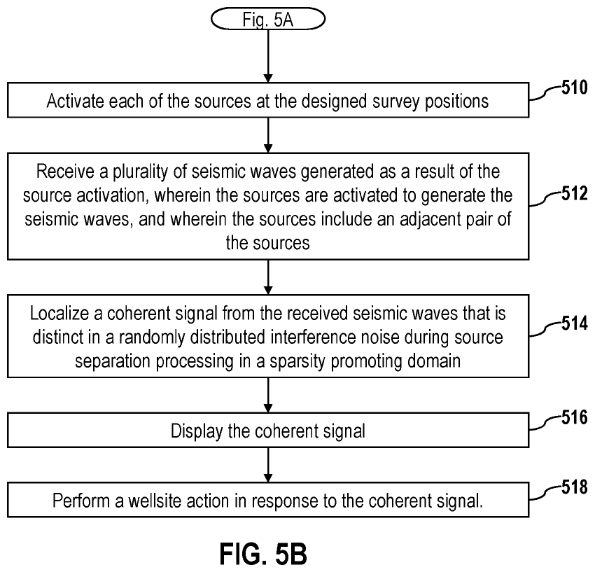

Referring now to FIG. 5A, the method 500 for localizing a coherent seismic signal from data collected during a seismic survey can include, but is not limited to including, designing 502 dithers having a pre-determined distribution within a dithers range. The dithers range is chosen for the seismic survey. The lower boundary of the dithers range is relative to the fraction of the nominal shotting times of sources of seismic waves in the seismic survey, and the upper boundary of the dithers range is a largest value compatible with constraints of the seismic survey. The seismic survey includes nominal positions of the sources, and the upper boundary of the dither range is based on a maximum separation time between when the sources are activated. The method 500 includes receiving 504 the constraints including environmental constraints and instrumental constraints. The environmental constraints include, for example, but not limited to, an energy threshold above which more energy cannot be injected over a time period. The amount of energy that can be injected is based on, for example, but not limited to, a minimum separation between two sources and the energy threshold. The method 500 includes designing 506 survey positions of each of the sources by adding the designed dithers to the nominal positions relative to an underlying grid of the seismic survey, and maintaining 508 a cycle time between the sources based on a design of the seismic survey.

Referring now to FIG. 5B, the method 500 includes activating 510 each of the sources at the designed survey positions, and receiving 512 a plurality of seismic waves generated as a result of the source activation. The sources are activated to generate the seismic waves, and the sources include an adjacent pair of the sources. The method 500 includes localizing 514 a coherent signal from the received seismic waves that is distinct in a randomly distributed interference noise during source separation processing in a sparsity promoting domain, displaying 516 the coherent signal, and performing 518 a wellsite action in response to the coherent signal. The wellsite action may be based upon the coherent signal. The wellsite action may be or may include generating and/or transmitting a signal (e.g., using a computing system) that instructs or causes a physical action to occur at a wellsite. The wellsite action may also or instead include performing the physical action at the wellsite. The physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

It should be noted that although the foregoing description is detailed with reference to a marine seismic survey acquisition, the embodiments presented herein may also be applied to land acquisition surveys. That is, the dithering techniques may be applied to between shots of vibrators and other land seismic acquisition components as described above.

While only certain features of disclosed embodiments have been illustrated and described herein, many modifications and changes will occur to those skilled in the art. It is, therefore, to be understood that the appended claims are intended to cover all such modifications and changes as fall within the true spirit of the present disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method for localizing a coherent seismic signal from data collected during a seismic survey, the method comprising:
designing dithers having a pre-determined distribution within a dithers range, wherein the dithers range is chosen for the seismic survey, wherein a lower boundary of the dithers range is relative to the fraction of the nominal shooting times of sources of seismic waves in the seismic survey, and wherein an upper boundary of the dithers range is a largest value compatible with constraints of the seismic survey, wherein the seismic survey includes nominal positions of the sources;
designing survey positions of each of the sources by adding the designed dithers to the nominal positions relative to an underlying grid of the seismic survey;
activating each of the sources at the designed survey positions;
receiving a plurality of seismic waves generated as a result of the source activations, wherein the sources are activated to generate the seismic waves, and wherein the sources include an adjacent pair of sources; and
localizing a coherent signal from the received seismic waves that is distinct in a randomly distributed interference noise during source separation processing in a sparsity promoting domain.

2. The method as in claim 1, wherein:
the upper boundary of the dither range is constrained by a maximum separation time between source activations,
the maximum separation time is related to the underlying grid and a nominal time separation between two consecutive activations for a given source, and
the lower boundary of the dither range is 4 seconds which is ±2 seconds around a point in the underlying grid.

3. The method as in claim 1 further comprising:
maintaining cycle times between the sources based on the seismic survey,
wherein the upper boundary of the dither range is based on a spacing of the sources or a distance between shots from the sources, a speed of a vessel towing the sources, and the cycle times of the sources.

4. The method as in claim 1, wherein:
the seismic waves propagate downward into subterranean geologic structures, and
the sources include one or more source arrays.

5. The method as in claim 1, wherein the sources include a plurality of air guns.

6. The method as in claim 1, wherein the seismic survey includes ocean bottom node sensors, the ocean bottom node sensors including one or more geophones, the geophones being single-component, two-component, or three-component, the ocean bottom node sensors including hydrophones.

7. The method as in claim 1, wherein the seismic survey includes one or more streamers traversing water, wherein a vessel tows the one or more streamers along a sail line, each of the one or more streamers including one or more streamer sensors, the one or more streamer sensors include one or more hydrophones, the one or more hydrophones create electrical signals in response to water pressure changes caused by reflected seismic waves arriving at the hydrophones.

8. The method as in claim 1, wherein the seismic survey includes one or more near field hydrophones in proximity to the sources.

9. The method as in claim 1, wherein:
the seismic survey includes one or more seismic sensors in one or more wells drilled into a subterranean geological structure, the one or more seismic sensors including fiber-optic sensors, geophones, and hybrid sensors including both fiber-optic sensors and the geophones, wherein source light signals are provided to the fiber-optic sensors, wherein the source light signals include laser impulses, wavelength tunable lasers, vertical cavity surface-emitting lasers, external cavity lasers, or distributed feedback lasers, wherein the hybrid sensors are disposed along a cable deployed in a borehole of the one or more wells, the one or more seismic sensors measuring strains caused by the seismic waves traveling along a sensor array, the one or more sensors are measuring ground motions caused by the seismic waves traveling along the sensor array, wherein the one or more seismic sensors convert received light data to electrical signals,
the sources being activated to generate the seismic waves, the sources being activated randomly, and
the one or more seismic sensors receiving reflected seismic waves and measuring the reflected seismic waves.

10. The method as in claim 1, comprising:
receiving environmental constraints and instrumental constraints, wherein the environmental constraints include an energy threshold above which more energy cannot be injected over a pre-selected time period, amount of energy that can be injected is based on a minimum separation between two sources, and maintaining an amount of time that allows for activation time between firing of consecutive of the sources;
displaying the coherent signal; and
performing a wellsite action in response to the coherent signal.

11. A computing system for localizing a coherent seismic signal from data collected during a seismic survey, the computing system comprising:
one or more processors; and
a memory system including one or more non-transitory computer-readable media storing instructions that, when executed by at least one of the one or more processors, cause the computing system to perform operations, the operations including:
designing dithers having a pre-determined distribution within a dithers range, wherein the dithers range is chosen for the seismic survey, wherein a lower boundary of the dithers range is relative to fraction of the nominal shotting times of sources of seismic waves in the seismic survey, and wherein an upper boundary of the dithers range is a largest value compatible with constraints of the seismic survey, wherein the seismic survey includes nominal positions of the sources;
designing survey positions of each of the sources by adding the designed dithers to the nominal positions relative to an underlying grid of the seismic survey;
activating each of the sources at the designed survey positions;
receiving a plurality of seismic waves generated as a result of the source activations, wherein the sources are activated to generate the seismic waves, and wherein the sources include an adjacent pair of sources; and
localizing a coherent signal from the received seismic waves that is distinct in a randomly distributed interference noise during source separation processing in a sparsity promoting domain.

12. The computing system as in claim 11, wherein
the upper boundary of the dither range is constrained by a maximum separation time between source activations,
the maximum separation time is related to the underlying grid and a nominal time separation between two consecutive activations for a given source, and
the lower boundary of the dither range is 4 seconds which is ±2 seconds around a point in the underlying grid.

13. The computing system as in claim 11, wherein the upper boundary of the dither range is based on a spacing of the sources or a distance between shots from the sources, a speed of a vessel towing the sources, and the cycle times of the sources.

14. The computing system as in claim 11, wherein:
the seismic waves propagate downward into subterranean geologic structures, and
the sources include one or more source arrays.

15. The computing system as in claim 11, wherein the sources include a plurality of air guns.

16. The computing system as in claim 11, wherein the seismic survey includes ocean bottom node sensors, the ocean bottom node sensors including one or more geophones, the one or more geophones being single-component, two-component, or three-component, the ocean bottom node sensors including hydrophones.

17. The computing system as in claim 11, wherein the seismic survey includes one or more streamers traversing water, wherein a vessel tows the one or more streamers along a sail line, each of the one or more streamers including one or more streamer sensors, the one or more streamer sensors include one or more hydrophones, the one or more hydrophones create electrical signals in response to water pressure changes caused by reflected seismic waves arriving at the hydrophones.

18. The computing system as in claim 11, wherein the seismic survey includes one or more near field hydrophones in proximity to the sources.

19. The computing system as in claim 11, wherein
the seismic survey includes one or more seismic sensors in one or more wells drilled into a subterranean geological structure, the one or more seismic sensors including fiber-optic sensors, geophones, and hybrid sensors including both fiber-optic sensors and the geophones, wherein source light signals are provided to the fiber-optic sensors, wherein the source light signals include laser impulses, wavelength tunable lasers, vertical cavity surface-emitting lasers, external cavity lasers, or distributed feedback lasers, wherein the hybrid sensors are disposed along a cable deployed in a borehole of the one or more wells, the one or more sensors measuring strains caused by the seismic waves traveling along a sensor array, the one or more seismic sensors are measuring ground motions caused by the seismic waves traveling along the sensor array, wherein the one or more seismic sensors convert received light data to electrical signals,
the sources being activated to generate the seismic waves, the sources being activated randomly, and
the one or more seismic sensors receiving reflected seismic waves and measuring the reflected seismic waves.

20. A non-transitory computer-readable medium for localizing a coherent seismic signal from data collected during a seismic survey, the non-transitory computer-readable medium storing instructions that, when executed by one or more processors of a computing system, cause the computing system to perform operations, the operations comprising:
designing dithers having a pre-determined distribution within a dithers range, wherein the dithers range is chosen for the seismic survey, wherein a lower boundary of the dithers range is ±2 seconds relative to fraction of the nominal shotting times of sources of seismic waves in the seismic survey, and wherein an upper boundary of the dithers range is a largest value compatible with constraints of the seismic survey, wherein the seismic survey includes nominal positions of the sources, wherein the upper boundary of the dither range is based on a maximum separation time between when the sources are activated, wherein the dither range is based on a spacing of the sources, a speed of a vessel towing the sources, and cycle times of the sources, wherein:
the seismic waves propagate downward into subterranean geologic structures,
the sources include one or more source arrays,
the sources include a plurality of air guns,
the seismic survey includes ocean bottom node sensors, the ocean bottom node sensors including one or more geophones, the one or more geophones being single-component, two-component, or three-component, the ocean bottom node sensors including hydrophones,
the seismic survey includes one or more streamers traversing water, wherein the vessel tows the one or more streamers along a sail line, each of the one or more streamers including one or more streamer sensors, the one or more streamer sensors include one or more hydrophones, the one or more hydrophones create electrical signals in response to water pressure changes caused by reflected seismic waves arriving at the hydrophones;
the seismic survey includes one or more near field hydrophones in proximity to the sources;
the seismic survey includes one or more seismic sensors in one or more wells drilled into a subterranean geological structure, the one or more seismic sensors including fiber-optic sensors, geophones, and hybrid sensors including both fiber-optic sensors and the geophones, wherein source light signals are provided to the fiber-optic sensors, wherein the source light signals include laser impulses, wavelength tunable lasers, vertical cavity surface-emitting lasers, external cavity lasers, or distributed feedback lasers, wherein the hybrid sensors are disposed along a cable deployed in a borehole of the one or more wells, the one or more sensors measuring strains caused by the seismic waves traveling along a sensor array, the one or more sensors are measuring ground motions caused by the seismic waves traveling along the sensor array, wherein the one or more seismic sensors convert received light data to digital signals,
the sources being activated to generate the seismic waves, the sources being activated randomly,
the one or more seismic sensors receiving reflected seismic waves and measuring the reflected seismic waves;
receiving the constraints including environmental constraints and instrumental constraints, wherein the environmental constraints include an energy threshold above which more energy cannot be injected over a time period, wherein an amount of the energy that can be injected is based on a minimum separation between two sources and the energy threshold;
designing survey positions of each of the sources by adding the designed dithers to the nominal positions relative to an underlying grid of the seismic survey;
maintaining a cycle time between the sources based on a design of the seismic survey;
activating each of the sources at the designed survey positions;
receiving a plurality of seismic waves generated as a result of the source activation, wherein the sources are activated to generate the seismic waves, and wherein the sources include an adjacent pair of the sources;
localizing a coherent signal from the received seismic waves that is distinct in a randomly distributed interference noise during source separation processing in a sparsity promoting domain;
displaying the coherent signal; and
performing a wellsite action in response to the coherent signal.
